(19) United States
(12) Patent Application Publication
(10) Pub. No.: US 2026/0307561 A1
(43) Pub. Date: Oct. 8, 2026

(54) Impact and Vibration Mitigation for Cushion Systems

(71) Applicant: Kalogon, Inc., Melbourne, FL (US)

(72) Inventors: Evan Rosenberg, Rockledge, FL (US); Timothy Balz, Melbourne, FL (US); Kaitlyn Davignon, Greenwood, IN (US); Christian Balcom, Melbourne, FL (US); Aaron Jones, Melbourne, FL (US); William Davignon, Melbourne, FL (US)

(73) Assignee: Kalogon, Inc., Melbourne, FL (US)

(21) Appl. No.: 19/201,657

(22) Filed: May 7, 2025

Related U.S. Application Data
(60) Provisional application No. 63/784,770, filed on Apr. 7, 2025.

(51) Int. Cl. B60N 2/52; B60N 2/50; B60R 21/0134; B60R 21/02; B60R 21/231

(52) U.S. Cl. CPC B60N 2/525; B60N 2/501; B60R 21/0134; B60R 21/231; B60R 2021/022

(57) ABSTRACT

The disclosed system provides a cushion system for a vehicle seat including a plurality of bladders and at least one valve connected to the bladders. The valve may include at least one actively controlled valve configured to selectively adjust air flow into or out of at least one bladder. The system may also include at least one controller configured to adjust a state of the actively controlled valve based on detection of at least one vibration or detection of an anticipated vehicle impact. This system may provide adaptive cushioning and support in response to driving conditions.

### CROSS-REFERENCE TO RELATED APPLICATIONS

This application claims priority to U.S. patent application Ser. No. 63/784,770, filed Apr. 7, 2025, the entire content of which is incorporated herein by reference.

### TECHNICAL FIELD

Various aspects of the present disclosure relate generally to systems and methods for cushions and, more particularly, to systems and methods for adaptive cushions with adjustable air bladders for providing customized support and pressure distribution.

### BACKGROUND

Cushion systems have long been used to provide comfort and support for individuals in various seating applications. These systems can range from simple foam padding to more complex arrangements involving multiple layers and adjustable components. For example, some existing cushion systems utilize air bladders as a means of providing adjustable support. However, existing air bladder systems often lack the ability to precisely control pressure distribution across different areas of the cushion. This limitation can result in suboptimal support and potential discomfort for users, particularly during extended periods of sitting.

Another challenge faced by conventional cushion systems is the ability to accommodate diverse body types and seating positions. Users may have varying weights, shapes, and postures, which can affect how pressure is distributed across the seating surface. Additionally, individuals may change their position frequently or experience different seating conditions throughout the day, such as when transitioning between various activities or modes of transportation.

Vibration and impact are additional factors that can affect user comfort and well-being in seating applications. These forces can be particularly pronounced in vehicle seating, where occupants may be subjected to sudden movements or prolonged periods of vibration. Existing cushion systems may struggle to effectively mitigate these disturbances, leading to fatigue or discomfort for users.

The integration of technology into cushion systems presents both opportunities and challenges. While sensors and control systems can enable more sophisticated pressure management, they also introduce complexity in terms of power management, durability, and user interface design. Balancing the benefits of advanced features with practical considerations such as cost, reliability, and ease of use remains an ongoing area of development in the field.

As cushion technology continues to evolve, there is a growing focus on personalization and adaptability. Users increasingly expect seating solutions that can learn from their preferences and automatically adjust to provide optimal comfort and support. This trend towards smarter, more responsive cushion systems opens up new possibilities for enhancing user experience across a wide range of seating applications.

The present disclosure is directed to overcoming one or more of these above-referenced challenges.

### SUMMARY OF THE DISCLOSURE

According to certain aspects of the disclosure, systems and methods are disclosed for adaptive cushions that provide customized support and pressure distribution.

In some embodiments, a cushion system for a seat of a vehicle is provided. The cushion system may include a plurality of bladders, at least one valve connected to the plurality of bladders, wherein the at least one valve includes at least one actively controlled valve configured to selectively adjust air flow into or out of at least one of the plurality of bladders, and at least one controller. The at least one controller may be configured to adjust a state of the at least one actively controlled valve based at least in part on detection of at least one vibration or detection of an anticipated impact of the vehicle.

In some embodiments, the cushion system for a seat of a vehicle may include one or more of the following features. The cushion system may further comprise at least one passive relief valve configured to vent air from at least one of the plurality of bladders when a pressure within the at least one bladder exceeds a predetermined threshold. The at least one controller may be further configured to detect at least one vibration based at least in part on data obtained from the plurality of bladders, and adjust an air pressure within at least one of the plurality of bladders based at least in part on the detected at least one vibration. The at least one controller may be further configured to analyze one or more noise patterns in the air pressure data to detect the at least one vibration. The at least one controller may be further configured to detect the at least one vibration based at least in part on data obtained from at least one sensor, and adjust an air pressure within at least one of the plurality of bladders based at least in part on the detected at least one vibration. The seat may comprise a seat portion and a backrest portion and at least one bladder of the plurality of bladders may be located in the seat portion. The at least one controller may be further configured to detect a first vibration, adjust a setting of the cushion system based at least in part on the first vibration, detect a second vibration after adjusting the setting, evaluate one or more changes in the second vibration relative to the first vibration, determine whether the second vibration or the one or more changes meet a target threshold, and iteratively adjust the setting and detect further subsequent vibrations until the target threshold is met. The at least one controller may be further configured to receive a signal indicating an anticipated impact of the vehicle, selectively adjust a state of the at least one actively controlled valve based at least in part on the received signal, and modify a pressure distribution within the plurality of bladders to enhance impact absorption or adjust a position of a user.

In some embodiments, a method of using a cushion system for a seat of a vehicle is provided. The method may include providing a plurality of bladders, connecting at least one valve to the plurality of bladders, wherein the at least one valve includes at least one actively controlled valve configured to selectively adjust air flow into or out of at least one of the plurality of bladders, and adjusting, by at least one controller, a state of the at least one actively controlled valve based at least in part on detection of at least one vibration or detection of an anticipated impact of the vehicle.

In some embodiments, the method of using a cushion system for a seat of a vehicle may include one or more of the following features. The method may further comprise connecting at least one passive relief valve to the plurality of bladders, wherein the at least one passive relief valve is configured to vent air from at least one of the plurality of bladders when a pressure within the at least one bladder exceeds a predetermined threshold. The method may further comprise detecting at least one vibration based at least in part on data obtained from the plurality of bladders, and adjusting an air pressure within at least one of the plurality of bladders based at least in part on the detected at least one vibration. The method may further comprise analyzing, by the at least one controller, one or more noise patterns in the air pressure data to detect the at least one vibration. The method may further comprise detecting the at least one vibration based at least in part on data obtained from at least one sensor, and adjusting an air pressure within at least one of the plurality of bladders based at least in part on the detected at least one vibration. The seat may comprise a seat portion and a backrest portion and at least one bladder of the plurality of bladders may be located in the seat portion. The method may further comprise detecting a first vibration, adjusting a setting of the cushion system based at least in part on the first vibration, detecting a second vibration after adjusting the setting, evaluating one or more changes in the second vibration relative to the first vibration, determining whether the second vibration or the one or more changes meet a target threshold, and iteratively adjusting the setting and detecting further subsequent vibrations until the target threshold is met. The method may further comprise receiving a signal indicating an anticipated impact of the vehicle, selectively adjusting a state of the at least one actively controlled valve based at least in part on the received signal, and modifying a pressure distribution within the plurality of bladders to enhance impact absorption or adjust a position of a user.

In some embodiments, a cushion system for a seat is provided. The cushion system may include a plurality of bladders, wherein each of the plurality of bladders may be made at least partially of an elastic material. The cushion system may comprise at least one of the following features: (i) at least one passive relief valve configured to vent air from at least one of the plurality of bladders when a pressure within the at least one bladder exceeds a predetermined threshold, or (ii) at least one bladder of the plurality of bladders includes a portion that is structurally modified relative to one or more other portions of the at least one bladder, wherein the structurally modified portion is configured to rupture in a controlled manner when subjected to a predetermined pressure such that air vents at a predetermined rate through the resulting opening in the at least one bladder.

In some embodiments, the cushion system for a seat may include one or more of the following features. The cushion system may comprise the at least one passive relief valve. The cushion system may comprise the structurally modified portion. The cushion system may further comprise at least one actively controlled valve configured to selectively adjust air flow into or out of at least one of the plurality of bladders, and at least one controller configured to adjust a state of the at least one actively controlled valve.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts a cushion system, according to aspects of the present disclosure.

FIG. 2 depicts a cushion system, according to aspects of the present disclosure.

FIG. 3 depicts a cushion system, according to aspects of the present disclosure.

FIG. 4 depicts a cushion system, according to aspects of the present disclosure.

FIG. 5 depicts a user interface display for controlling a cushion system, according to aspects of the present disclosure.

FIG. 6 depicts a user interface display for controlling a cushion system, according to aspects of the present disclosure.

FIG. 7 depicts a seat assembly including a cushion system, according to aspects of the present disclosure.

FIG. 8 depicts a seat assembly including a cushion system, according to aspects of the present disclosure.

FIG. 9 depicts a seat assembly including a cushion system, according to aspects of the present disclosure.

FIG. 10 depicts a prior art cushion system with a user.

FIG. 11 depicts a cushion system with a user, according to aspects of the present disclosure.

FIG. 12 depicts an exemplary method for an initialization sequence for a cushion system, according to aspects of the present disclosure.

FIG. 13 depicts an exemplary method for providing a visual representation for a cushion system, according to aspects of the present disclosure.

FIG. 14 depicts an exemplary method for state detection for a cushion system, according to aspects of the present disclosure.

FIG. 15 depicts an exemplary method for impact and/or vibration mitigation for a cushion system, according to aspects of the present disclosure.

FIG. 16 depicts an exemplary system that may execute techniques presented herein.

### DETAILED DESCRIPTION

The present disclosure generally relates to systems and methods for cushions and, more particularly, to systems and methods for adaptive cushions that utilize adjustable air bladders to provide customized support and pressure distribution for users. These systems may incorporate sensors, control mechanisms, and/or user interfaces to dynamically adjust cushion properties based on user characteristics, movements, and environmental factors. The cushion systems described herein may be applicable to various seating applications, including but not limited to vehicle seats, office chairs, and medical support surfaces. By leveraging advanced technologies and innovative design approaches, these cushion systems aim to enhance user comfort, reduce fatigue, and accommodate a wide range of body types and seating scenarios.

### 1. Cushion System Designs and Methods

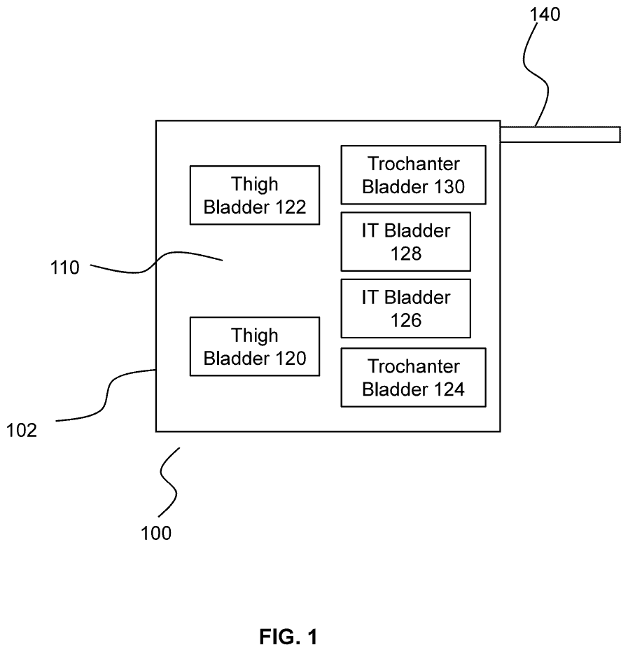

FIG. 1 depicts a cushion system 100. The cushion system 100 includes a cushion support 102 that serves as a foundation or support for the arrangement of multiple air bladders. The cushion support 102 may be constructed from a supportive material such as foam or a similar substance that provides structural integrity to the system.

In some embodiments, the cushion system 100 includes at least one air bladder. In some embodiments, the cushion system includes at least two air bladders arranged in a specific configuration on the cushion support 102. In some embodiments, the cushion system includes a plurality of bladders, wherein the bladders vary in at least one of size, shape, or function to provide customized support across different anatomical regions.

In some embodiments, the air bladders in the cushion system 100 may be constructed at least partially from elastic materials. As described in greater detail below, the elastic properties of the bladder materials may allow for volume expansion when there is a sudden increase in pressure, even without active or passive relief systems engaged. This expansion capability may provide an additional mechanism for impact dissipation. When an impact occurs, the elastic nature of the bladder material may allow it to stretch and deform, increasing its volume temporarily. This deformation may help absorb and distribute the energy from the impact.

In the embodiment depicted in FIG. 1, the cushion system 100 includes a left thigh bladder 120, a right thigh bladder 122, a left trochanter bladder 124, a right trochanter bladder 130, a left ischial tuberosity (IT) bladder 126, and a right IT bladder 128. Thigh bladders 120 and 122 are positioned proximal a front end of the cushion support 102. These thigh bladders may be designed to provide support and pressure distribution for a user's thighs. The thigh bladders 120 and 122 may have the same shape but different hose routing. The thigh bladders may be fluidly connected to maintain the same pressure, although in some embodiments they could be individually controlled. By adjusting the pressure in the thigh bladders, the height and load carried by a user's thighs may be modified. This adjustment capability may allow for changes in the angle at which a user's body sits in the chair. In some cases, increasing the pressure in the thigh bladders may effectively increase the distance between the cushion and a footplate, accommodating changes in footwear height or user growth without requiring adjustment of the footplate itself.

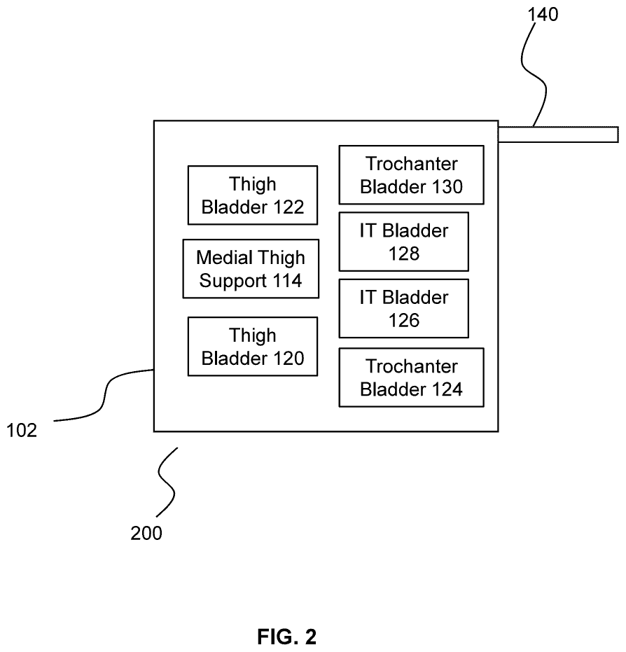

In some embodiments, an opening 110 may be positioned between the left thigh bladder 120 and the right thigh bladder 122, separating these two bladders. In some embodiments, such as in the cushion system 200 shown in FIG. 2, a medial thigh support 114 may be located in the opening 110. The medial thigh support 114 may be construed at least partially from a material such as foam and may rise above the surface on which the thigh bladders are positioned. This elevated structure may help prevent the user's thighs from sliding inward or the occupant from sliding their pelvis forward and out of the cushion. In some aspects, the medial thigh support 114 may be removable or adjustable, allowing for customization based on user needs or preferences. The size and/or shape of the medial thigh support 114 may thus be variable, providing flexibility in design to accommodate different user body types or seating requirements. This variability may allow for adjustments to the height, width, or contour of the medial thigh support 114 to optimize its effectiveness in maintaining proper user positioning while ensuring comfort.

In some embodiments, the cushion system 100 includes a row of bladders proximal a rear end of the cushion support 102. The row of bladders may include one or more trochanter bladders 124 and 130, positioned at the outer edges, and one or more IT bladders 126 and 128, located between them. The trochanter bladders 124 and 130 may be configured to support the hip region, while the IT bladders 126 and 128 may be designed to provide customized support for the ischial tuberosities. The trochanter bladders 124 and 130 may be mirrored in shape and individually controllable.

In some embodiments, the IT bladders 126 and 128 may be mirrored in shape to each other and individually controllable. These bladders may be designed to provide support and pressure distribution for the ischial tuberosities, which are the bony prominences at the bottom of the pelvis that bear a significant portion of body weight when seated. The individual control of these bladders may allow for precise adjustment of pressure and support in this critical area.

In some embodiments, a hose 140 is connected to one or more of the air bladders, allowing for inflation and deflation control. This hose 140 may be routed along the cushion support 102 to connect with each of the air bladders in the system. The hose 140 may lead to a control system that regulates air flow to and from the bladders.

In some embodiments, the arrangement of the bladders in cushion system 100 creates distinct zones for supporting different areas of a user's body. This configuration may allow for individualized pressure management and support across various anatomical regions.

In some embodiments, the cushion system 100 may incorporate additional features such as pressure sensors, temperature regulators, or other components that enhance its adaptive capabilities. The specific shape, size, and arrangement of the bladders may be customized to suit different applications or user requirements.

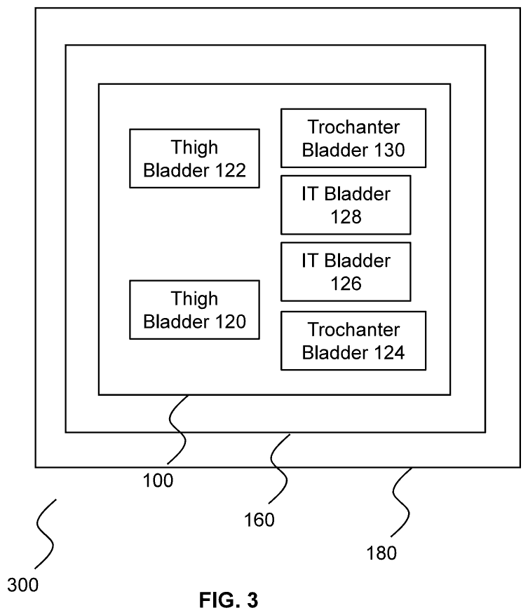

FIG. 3 depicts a cushion assembly 300. The cushion assembly 300 includes a cushion system 100, which includes a cushion support 102 and a plurality of air bladders 120, 122, 124, 126, 128, 130. An inner cover 160 is designed to encase the cushion system 300. The inner cover 160 may incorporate a water-resistant outer material that may be stretchy to accommodate the shape of the internal components. This water-resistant material may serve as a barrier to prevent liquids such as urine, sweat, or rain from reaching the internal components of the cushion. This feature may be particularly beneficial for users who may experience incontinence or in outdoor applications where moisture protection is necessary.

In some embodiments, the inner cover 160 may be removable independently of an outer cover 180. This design may allow the inner cover 160 to function as an adequate cushion cover even when the outer cover 180 is removed, such as during cleaning or maintenance. This feature may enable users to continue using the cushion while the outer cover 180 is being washed or replaced.

In some embodiments, the outer cover 180 forms the outermost layer of the cushion system 100. The outer cover 180 may also incorporate a stretch and/or water-resistant material. In some aspects, the outer surface of the outer cover 180 may have a lower coefficient of friction compared to the outer surface of the inner cover 160. This property may help reduce friction between the cushion and the user's clothing, enhancing comfort and ease of movement.

In some implementations, the outer cover 180 may be customizable based on specific requirements. For instance, users may have the option to use an outer cover 180 with either air-permeable or water-resistant properties, depending on the intended use case or user needs.

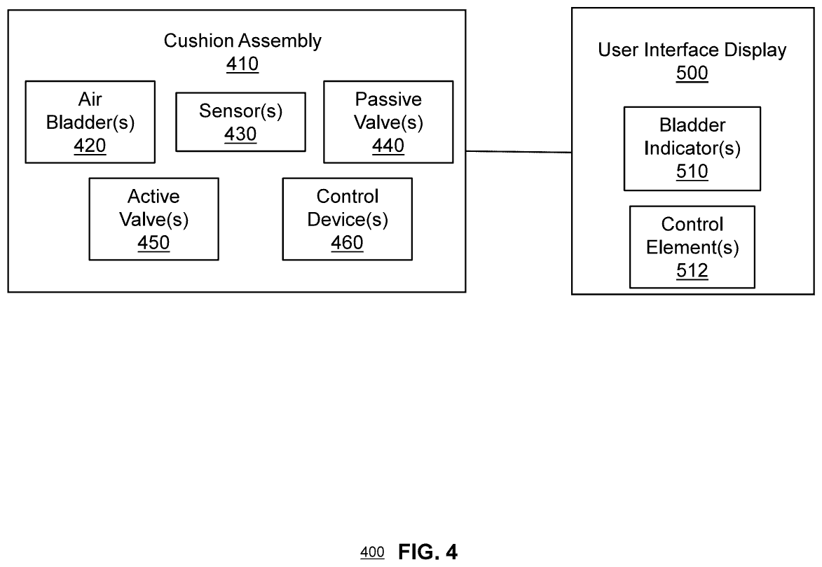

FIG. 4 depicts a cushion system 400 that includes various components for providing adjustable support and pressure distribution. The cushion system 400 comprises a cushion assembly 410 that incorporates one or more air bladders 420, one or more pressure sensors 430, one or more passive valves 440, and one or more active valves 450.

In some embodiments, the air bladders 420 may be arranged in multiple zones within the cushion assembly 410. As described in reference to FIGS. 1-3, each zone may correspond to different anatomical regions, such as the thighs, hips, or ischial tuberosities. The air bladders 420 may vary in size, shape, or volume to provide targeted support to specific body areas.

In some embodiments, the pressure sensors 430 may be strategically placed within the cushion assembly 410 to monitor pressure distribution across the support surface. In some aspects, these sensors may provide real-time data on the pressure exerted by the user's body on different areas of the cushion. This information may be used to detect pressure points or areas of high pressure that may require adjustment.

In some embodiments, the cushion system 400 may include passive valves 440 and/or actively controlled valves 450 for controlling air flow within the air bladders 420. Passive valves 440 may operate without external control, responding to pressure changes automatically. Active valves 450 may be electronically controlled to adjust air flow based on sensor data or user input.

In some embodiments, at least one bladder of the air bladders 420 may include one or more portions or regions that are structurally modified relative to one or more other portions or regions of the bladder. This structurally modified portion may be configured to rupture in a controlled manner when subjected to a predetermined pressure, allowing air to vent at a predetermined rate through the resulting opening in the at least one bladder.

In some embodiments, a control device 460 may be integrated into the cushion system 400 to manage the operation of various components. In some embodiments, the control device 460 or components thereof may be located inside or integrated into the cushion support 102. This configuration may allow for a more compact and self-contained cushion system 400. The integration of the control device 460 within the cushion support 102 may provide protection for the electronic components and reduce the need for external connections. In some embodiments, the control device 460 or components thereof may be positioned external to the cushion support 102. When located externally, the control device 460 may be connected to the cushion system 400 through various means. In some embodiments, a wired connection may be used to link the external control device 460 to the components within the cushion assembly 410. This wired connection may provide a direct and reliable communication pathway for data transmission and control signals. In some embodiments, the external control device 460 may utilize wireless communication technologies to interface with the cushion system 400. Wireless connectivity may offer greater flexibility in terms of control device placement and may reduce the need for physical cable connections. Various wireless protocols may be employed, such as Bluetooth, Wi-Fi, or proprietary wireless standards, depending on the specific requirements of the application.

In some embodiments, the control device 460 may process data from the pressure sensors 430, control the active valves 450, and/or interface with external systems or user interfaces. In some embodiments, the control devices 460 may include controllers, microprocessors, memory units, and communication modules to enable sophisticated control algorithms and data logging capabilities. In some embodiments, the cushion system 400 may include a control device connected to the cushion assembly 410 by an air hose. The control device may be configured to sense pressure in one or more of the air bladders 420, provide air to the bladders, and/or vent air from the bladders. In some implementations, the cushion assembly 410 may include a single inlet for receiving air, allowing the control device to manage air flow for multiple bladders through a centralized connection point. In some embodiments, the control device may incorporate various components within a compact enclosure, such as an injected molded enclosure. These components may include an inlet/outlet port, a pump, a vent, a pressure sensor, a processor, and/or a memory. In some aspects, the control device may be designed to be handheld, allowing for easy manipulation by a user of the cushion or a caregiver.

In some embodiments, the control device may be pneumatically coupled to the cushion assembly 410 through its inlet and outlet port, pump, vent, and pressure transducer. A battery may provide power to the various components, including the pump, vent, pressure transducer, processor, and user interface. The processor may be configured to implement control operations and execute algorithms for managing the cushion system's performance. The integration of these control device features with the cushion assembly 410 may allow for more sophisticated pressure management and user comfort optimization. For example, the control device may use data from the pressure sensors 430 to dynamically adjust the air bladders 420 through the active valves 450, responding to changes in user position or pressure distribution in real-time.

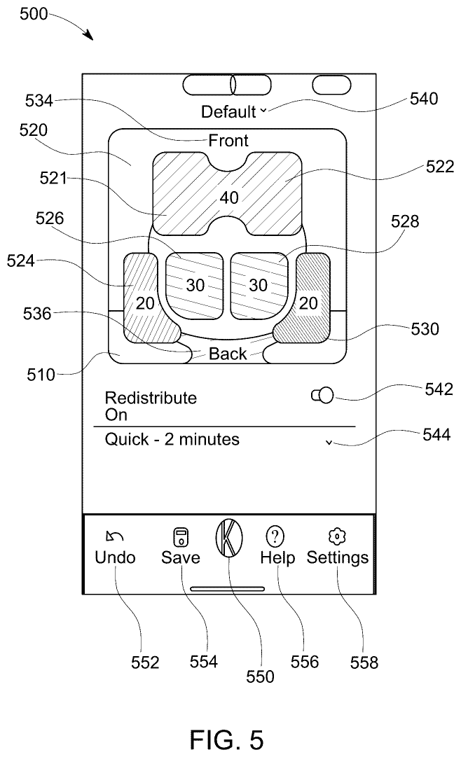

In some embodiments, the cushion system 400 may interface with a user interface display 500 that provides visual feedback and control options to users or caregivers. As described in greater detail in reference to FIG. 5, the display 500 may include a visual representation of the cushion assembly or a seat incorporating the cushion assembly.

In some embodiments, the display 500 may incorporate various visual representations to convey information about the cushion system's state and pressure distribution. These representations may take different forms to suit various user preferences and application requirements. In some embodiments, the display 500 may show a direct representation of the bladders, where each bladder is visually depicted in its relative position within the cushion. In some embodiments, the display 500 may present a more abstract map of the seat area without explicitly showing individual bladders.

In some embodiments, the display may show the current pressure or inflation status of different zones within the cushion assembly 410. This visual representation may use color coding, numerical indicators, or graphical elements to convey information about the state of the air bladders 420. As described in greater detail in reference to FIG. 5, the display 500 may incorporate control elements 512 that allow users to adjust settings, select operating modes, or initiate specific functions of the cushion system 400. These control elements 512 may include touchscreen buttons, sliders, or other interactive elements that enable user input and system control.

In some embodiments, the display may include model or map of the cushion system or the seat that dynamically updates to reflect changes in the air bladder pressures and user positioning. In some embodiments, the model may be a three dimensional (3D) model. The model may provide a visual representation of how the cushion conforms to the user's body in real-time. The model may show individual air bladders or cells within the cushion, each of which may be represented by a distinct shape or segment. As the system adjusts the amount of air in these cells to better conform to the user, the model may update to reflect these changes. For example, cells with increased air pressure may appear more inflated or raised in the model, while cells with decreased pressure may appear flatter or more compressed. In some embodiments, color coding may be used in the model to indicate pressure levels in different areas of the cushion. For instance, areas of high pressure may be displayed in red, while areas of lower pressure may be shown in blue or green. If a user leans to the left or right, the colors in the 3D model may change in real-time, proportionally to the pressure response in the corresponding air bladders. This dynamic color mapping may allow users or caregivers to quickly identify areas of increased pressure or potential concern.

In some embodiments, the model may also visually demonstrate how the cushion shifts and conforms to the user's body. As the cushion adapts to provide better support, the model may show an increase in the apparent surface area of contact between the user and the cushion. This may be represented by a gradual expansion or flattening of the cushion's surface in the model. To illustrate user immersion, the 3D model may include a silhouette or outline representing the user's body. As the cushion conforms more closely to the user, this silhouette may appear to sink deeper into the cushion surface in the model. The depth of immersion may vary across different areas of the cushion, providing a detailed visual representation of how the cushion is supporting different parts of the user's body. In some embodiments, the 3D model may allow for rotation or different viewing angles, enabling users or caregivers to examine the cushion's conformity from various perspectives. This feature may provide a more comprehensive understanding of the cushion's performance and the user's positioning. The 3D model may update continuously based on data from the pressure sensors and air bladder adjustments, providing a real-time visualization of the cushion's adaptive behavior. This dynamic representation may assist in fine-tuning cushion settings and monitoring user comfort over time.

FIG. 5 illustrates a user interface display 500 that may be used to monitor and control the cushion system. The display 500 includes a visual representation of bladders 510 that provides a graphical depiction of the cushion's various support zones. This representation may be designed to intuitively communicate the current state of the cushion system to users or caregivers.

In some embodiments, the visual representation of bladders 510 may include multiple bladder indicators corresponding to different areas of the cushion. These may include one or more thigh bladder indicators 520. In some embodiments, the thigh bladder indicator may be further divided into a left thigh bladder indicator 521 and a right thigh bladder indicator 522. In some embodiments, the thigh bladder indicator 520 may include two separate indicators, allowing for independent representation and control of the left and right thigh regions. The representation may also include one or more trochanter bladder indicators 524 and 530 and/or one or more IT bladder indicators 526 and 528. As described above, these indicators may use color, shading, or numerical values to represent the current pressure or inflation status of each bladder zone. The display 500 may include orientation markers such as a front indicator 534 and a rear indicator 536 to help users understand the spatial layout of the cushion system. This may be particularly helpful for users or caregivers who are adjusting settings without direct visual access to the physical cushion.

In some embodiments, the display 500 may incorporate interactive control elements that allow users to adjust cushion settings. For example, a mode selector 540 may enable users to choose between different operating modes, such as comfort, pressure relief, or posture support. A toggle switch 542 may be used to activate or deactivate specific features or functions of the cushion system. The display 500 may also include a duration selector 544, which could allow users to set time intervals for automatic adjustments or pressure redistribution cycles. This feature may be useful for implementing timed pressure relief protocols or adapting the cushion system to different activities throughout the day. The display 500 may also a set of control icons may provide quick access to common functions or settings. These may include a home button 550, an undo button 552 for reverting recent changes, a save button 554 for storing custom settings, a help button 556 for accessing user guidance, and/or a settings button 558 for accessing more detailed system configuration options.

As described above, in some embodiments, each bladder indicator in the visual representation of bladders 510 may include additional visual elements to convey more detailed information about the state of the corresponding bladder. These elements may include numerical values displayed within or adjacent to each bladder indicator, representing the current pressure level in that specific bladder. For example, the thigh bladder indicators 520, trochanter bladder indicators 524 and 530, and IT bladder indicators 526 and 528 may each display a numerical value indicating the pressure in units such as millimeters of mercury (mmHg) or kilopascals (kPa).

For example, in FIG. 5, the thigh bladder indicator 520 shows a value of 40 and may be displayed in a first color. The trochanter bladder indicator 524 displays a value of 20 and may be shown in a second color, while the trochanter bladder indicator 530 may shows a value of 20 but may be presented in a third color. The second and third colors may be different colors or different shades of the same color, indicating that the degree of conformance of each bladder to the user's body is different. In some embodiments, certain colors may be used to represent different levels of conformance. For example, cooler colors like blue may indicate better conformance to the user's body, while warmer colors like red may suggest worse conformance. Additionally, the system may use variations in shade intensity to further differentiate conformance levels. Lighter shades of a color may represent better conformance, while darker shades of the same color may indicate worse conformance. Thus, the visual representation may employ a combination of colors, shades, and numerical values to provide a comprehensive view of the cushion's performance. For instance, a bladder indicator displayed in light blue with a higher numerical value may suggest optimal conformance and support, while a bladder indicator shown in dark red with a lower numerical value may indicate an area of potential concern that may require adjustment.

In some embodiments, the color coding and shading may be dynamic, updating in real-time as the pressure in each bladder changes. This may allow users or caregivers to quickly identify areas that may need attention or adjustment. The combination of visual cues and numerical data may provide an intuitive and informative interface for monitoring and managing the cushion system's performance.

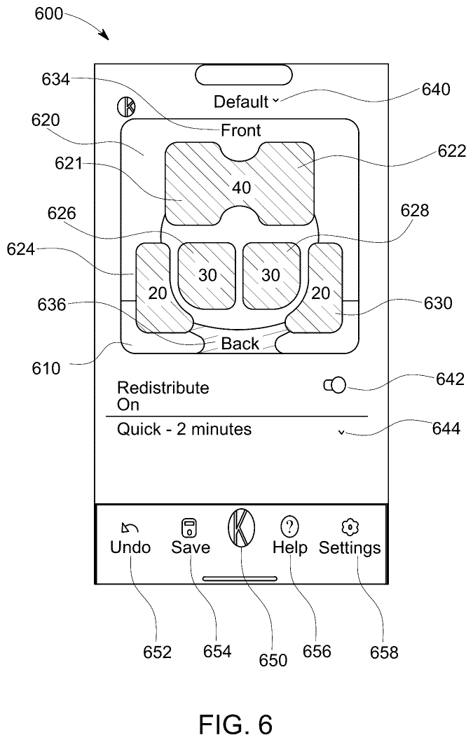

For example, FIG. 6 depicts a similar user interface display as FIG. 5, but with changes in the color and shading of certain bladder indicators. These changes may reflect improvements in the conformance of specific bladders to the user's body after adjustments have been made to the cushion system's settings. For example, one or both of the trochanter bladder indicators 624 and 630 in FIG. 6 may be shown in a cooler color, such as blue, or a lighter shade of blue compared to the corresponding trochanter bladder indicator 524 or 530 in FIG. 5. Similarly, one or both of the IT bladder indicators 626 and 628 in FIG. 6 may display different colors or shades compared to their counterparts in FIG. 5.

These visual changes may indicate that the system has made adjustments, either automatically or in response to user input, to improve the conformance of these bladders to the user's body. The adjustments may involve modifying air pressure in one or more bladders or altering other settings of the cushion system. The updated visual representation in FIG. 6 may allow users or caregivers to quickly assess the impact of these adjustments on the overall performance of the cushion system.

In some cases, the transition from FIG. 5 to FIG. 6 may represent an initialization sequence or before-and-after scenario, where FIG. 5 shows the initial state of the cushion system, and FIG. 6 displays the improved state after adjustments have been made. This visual comparison may help users understand how changes in the cushion system's settings can affect comfort and support across different areas of the body. The dynamic nature of the display may allow for real-time updates as adjustments are made, providing immediate feedback on the effects of changes to the cushion system's configuration. This feature may be particularly useful for fine-tuning the cushion settings to achieve optimal comfort and support for individual users.

In some embodiments, the bladder indicators may incorporate graphical elements such as contour lines or gradient fills to visually represent the shape and degree of inflation of each bladder. These graphical representations may dynamically update to reflect changes in bladder pressure and conformance to the user's body in real-time. The visual representation may also include animated elements, such as subtle pulsing or morphing effects, to indicate active pressure adjustments or to draw attention to specific bladders that may require user attention.

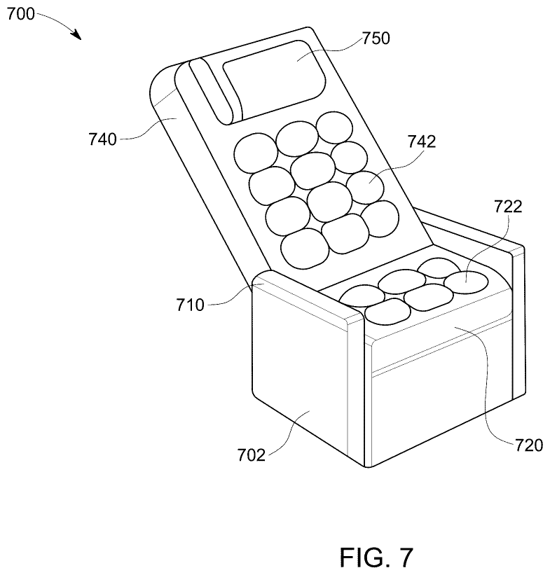

FIGS. 7-9 depict various exemplary seat configurations into which a cushion system of the present disclosure may be incorporated. These figures illustrate different seat designs and arrangements, demonstrating the versatility and adaptability of the cushion system across various seating applications.

FIG. 7 depicts an exemplary seat assembly, according to aspects of the present disclosure. The seat assembly includes a seat 700 supported by a seat frame 702. The seat 700 incorporates a seat cushion 720 that may include a bladder array 722 positioned within or along the seat cushion 720. An armrest 710 extends from the seat frame 702, providing additional support for the user's arms. The upper portion of the seat assembly comprises a backrest cushion 740 that includes a bladder array 742. The bladder arrays 722 and 742 may correspond to any of the bladder configurations or cushion systems disclosed herein. For example, the bladder arrays 722 and 742 may include multiple individually controllable air bladders arranged in a specific pattern to provide customized support and pressure distribution. A headrest 750 is positioned at the top of the backrest cushion 740, offering support for the user's head and neck. In some embodiments, the headrest 750 may include a bladder array.

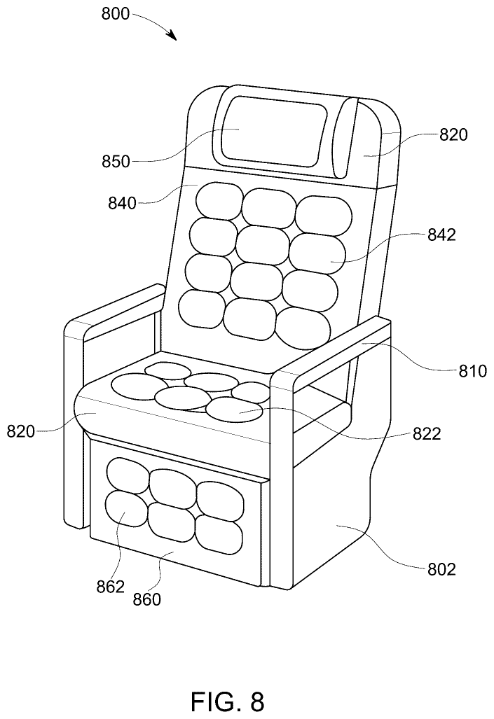

FIG. 8 depicts a seat assembly, according to aspects of the present disclosure. The seat assembly includes a seat 800 supported by a seat frame 802. An armrest 810 extends from the seat frame 802. The seat 800 incorporates a seat cushion 820 that may include a bladder array 822 positioned within or along the seat cushion 820. The seat assembly includes a seat 700 supported by a seat frame 702. A backrest cushion 840 extends upward from the rear portion of the seat 800. The backrest cushion 840 includes a bladder array 842 that can be adjusted to provide varying levels of support. Above the backrest cushion 840, a headrest 850 may be mounted to provide head and neck support. At the lower portion of the seat 800, a footrest cushion 860 may be positioned. The footrest cushion 860 may include a bladder array 862 that can be adjusted to support the user's legs and feet. The bladder arrays 822, 842, and 862 may correspond to any of the bladder configurations or cushion systems previously described. For instance, they may include multiple air bladders arranged in zones to target specific areas of the back, such as the lumbar region or upper back.

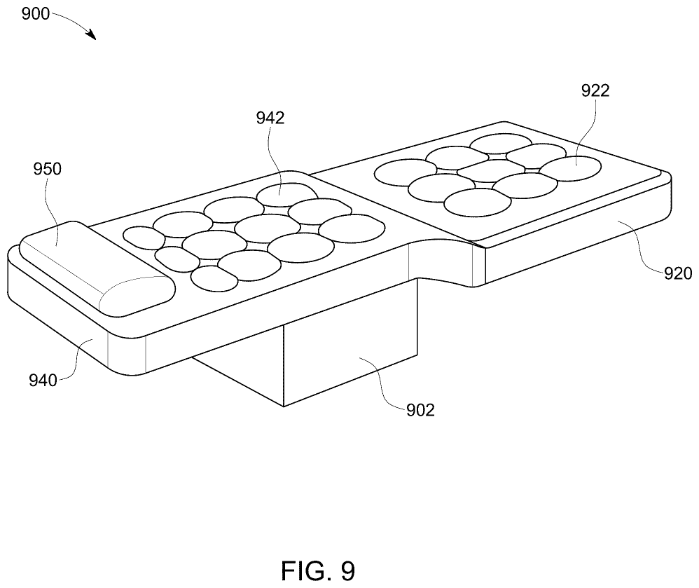

FIG. 9 depicts an exemplary seat assembly, according to aspects of the present disclosure. The seat assembly includes a seat 900 supported by a frame 902 that provides structural support for the various components. A lower cushion 920 is positioned on the lower portion of the frame 902 and includes a bladder array 922 integrated within its structure. An upper cushion 940 extends upward from the rear of the upper cushion 920 and contains a bladder array 942 within its construction. The bladder arrays 922 and 942 may also correspond to any of the bladder configurations or cushion systems disclosed herein. They may, for instance, include multiple individually controllable air bladders arranged to provide customized support along the length of the user's back. A headrest 950 may be positioned at the top of the backrest cushion 940.

In each of the configurations shown in FIGS. 7-9, the bladder arrays may be connected to control systems, pressure sensors, and user interfaces as described earlier in this disclosure. This integration may allow for dynamic adjustment of support and pressure distribution based on user needs, preferences, or changing seating conditions. The bladder arrays in these seat assemblies may also incorporate features such as pressure relief cycles, posture correction capabilities, or vibration mitigation functionalities as described in other sections of this disclosure. The assemblies shown in FIGS. 7-9 may be used in various applications, including but not limited to office chairs, vehicle seats, medical chairs, or specialized seating for individuals with specific support needs. The incorporation of the cushion systems disclosed herein into these various seat designs demonstrates the adaptability and broad applicability of the cushion technology across different seating contexts.

The bladder arrays shown in FIGS. 7-9 may be incorporated into the seat cushion in various ways as described herein. In some embodiments, the bladder arrays may be integrated seamlessly within the cushion structure, creating a smooth and uniform surface. This integration may result in the bladder arrays being flush with the cushion surface, making them virtually unnoticeable to the user. The seamless integration of bladder arrays may enhance user comfort by providing a uniform seating or lying experience while still allowing for the customizable support and pressure distribution capabilities of the adaptive cushion system. This design approach may be particularly beneficial in applications where a sleek, uninterrupted surface appearance is desired, such as in high-end vehicle seating or modern furniture design. In some embodiments, the bladder arrays may be designed to be visibly distinct or palpable to the user, with individual bladders discernible through the cushion surface. This configuration may allow users to visually or tactilely identify specific support zones, which may be preferable in certain applications where users desire a more apparent indication of the cushion's adaptive capabilities.

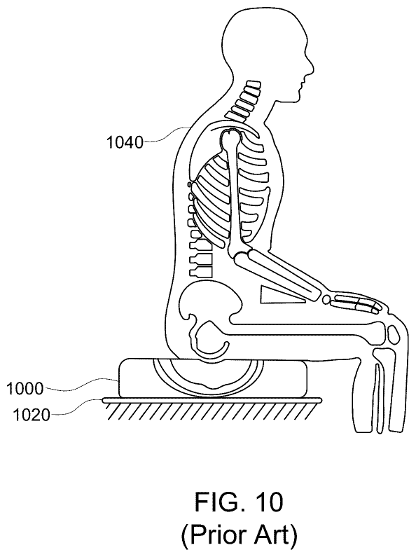

FIG. 10 depicts a prior art cushion system and the interaction between the cushion and user. FIG. 10 shows cushion 1000 positioned on support surface 1020. The cushion 1000 may be constructed primarily of foam or similar materials without adaptive air bladders. The foam-only construction of cushion 1000 may have limited capacity to absorb and distribute impact forces. As a result, when an impact occurs, a significant portion of the energy may be transferred directly to the user 1040. This energy transfer may lead to increased spinal loading, as the user's body, particularly the spine, may absorb and dissipate the remaining energy after the impact. The relatively rigid nature of the support surface 1020 beneath the foam cushion 1000 may further contribute to this effect, causing discomfort or increased risk of injury during impact events.

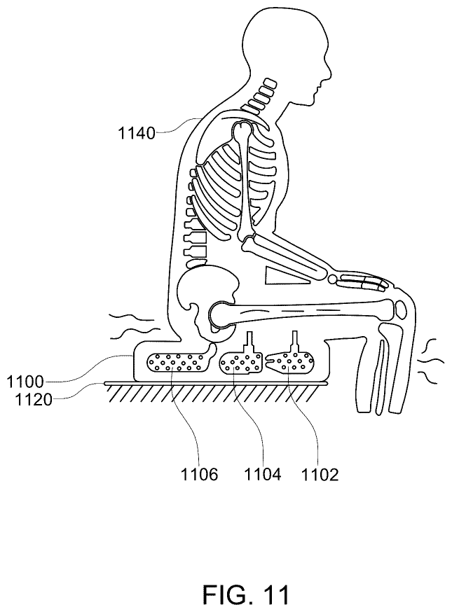

FIG. 11 depicts a cushion system, according to aspects of the present disclosure. FIG. 11 shows the interaction between a user 1140 and cushion 1100 during an impact event. The cushion 1100 is positioned on support surface 1120. The cushion 1100 includes multiple bladders 1102, 1104, and 1106. In this configuration, the cushion system may incorporate air bladders made with elastic materials. These bladders may be designed to expand and contract in response to pressure changes, providing a dynamic support system. When an impact occurs, the air bladders 1102, 1104, and 1106 may vent air, allowing for controlled deformation and energy absorption.

The elastic properties of the bladder materials may allow for volume expansion when there is a sudden increase in pressure, even without active or passive relief systems engaged. This expansion capability may provide an additional mechanism for impact dissipation. As the bladders deform and expand, they may absorb and distribute the energy from the impact, reducing the amount of force transmitted directly to the user 1140. During an impact event, the venting of air from bladders 1102, 1104, and 1106 may allow for a controlled collapse of the cushion system. This controlled collapse may extend the duration of the impact event, reducing peak forces experienced by the user 1140. The ability of the bladders to deform and vent air may also help in distributing the impact force over a larger area, which may further reduce localized pressure points. The elastic nature of the bladder materials may also contribute to the system's ability to recover after an impact. Once the impact force subsides, the bladders may return to their original shape, providing continued support and comfort for the user 1140. This enhanced performance may result in reduced spinal loading and lower risk of discomfort or injury for the user during impact events. The system's ability to dynamically respond to pressure changes may provide a more adaptable and responsive cushioning solution across various usage scenarios.

The cushion 1100 and bladders 1102, 1104, and 1106 shown in FIG. 11 are representative examples for illustrative purposes. The cushion 1100 may take the form of any of the cushion configurations discussed herein. For instance, the cushion 1100 may correspond to the cushion systems described in relation to FIGS. 1-9, incorporating various bladder arrangements, support structures, and adaptive features. The number, size, shape, and arrangement of bladders may vary depending on the specific implementation and intended application of the cushion system. In some embodiments, the cushion 1100 may include additional components such as foam layers, covers, or integrated sensors as described in previous embodiments. The principles of impact absorption and pressure distribution illustrated in FIG. 11 may apply across different cushion configurations, with the specific mechanics and performance characteristics varying based on the particular design and components used in each implementation.

### 2. Initialization Sequences for Cushion Systems

In some embodiments, the cushion system may implement an initialization sequence when a user first sits on the cushion. The initialization process may apply or use any of the features described with respect to FIGS. 1-11 or otherwise described herein.

### 2.A. Initialization Sequences

An initialization sequence or process may allow the system to calibrate and adjust to the user's specific body characteristics and preferences. In some embodiments, an initialization sequence may occur when a user first sits on the cushion system. The initialization sequence may begin by inflating at least one bladder to a first known pressure and volume. This initial state may provide a baseline for subsequent measurements and calculations. When the user sits on the cushion, applying at least a predetermined pressure to the system, the cushion may measure a second pressure in the at least one bladder. Using the relationship between the first pressure, first volume, and the measured second pressure (P1V1=P2V2), the system may determine a force, pressure, or volume distribution across one or more of the bladders. In some embodiments, using the relationship between the first pressure, first volume, and the measured second pressure, the system may calculate a second volume for the at least one bladder.

Based on this determined force, pressure, or volume distribution, the system may determine at least one characteristic relating to the user. These characteristics may include body shape, weight distribution, or overall mass. For example, a larger change in pressure may indicate a heavier user or a user with a different body shape that exerts more force on the bladder. After determining these user characteristics, the system may adjust the air pressure in one or more of the bladders. This adjustment may be based on the determined characteristics to provide optimal support and pressure distribution for the specific user. For instance, if the system determines that the user has a higher concentration of weight in one area, it may increase pressure in bladders supporting that area while decreasing pressure in others.

In some embodiments, the system may repeat this process for multiple bladders or zones within the cushion, building a comprehensive profile of the user's body and weight distribution. In some cases, the system may also incorporate user feedback during this initialization process, allowing for fine-tuning of pressure settings based on user comfort preferences. This initialization sequence may allow the cushion system to quickly adapt to each new user, providing a personalized seating experience from the moment they sit down. The use of this initialization sequence may enable the system to make these adjustments without requiring additional sensors or complex measurement systems, simplifying the overall design and reducing costs.

In some embodiments, when a user initially sits on the cushion, the system may display a visual representation of the cushion and its air bladders on a user interface, as shown in FIG. 5. This initial display may indicate that the cushion does not yet perfectly conform to the user's body shape. As described above, the visual representation may use colors, shading, or other graphical indicators to show the current state of conformity between the cushion and the user's body. As the initialization sequence progresses, the system may adjust the amount of air in various bladders to better conform to the user's body shape and weight distribution. These adjustments may be reflected in real-time on the display, as depicted in the updated display of FIG. 6. For example, the colors or shading of bladder indicators may change to represent improved conformity and pressure distribution.

In some embodiments, if the user shifts their weight or leans to one side during the initialization process, the visual representation may update dynamically. The colors or patterns of the bladder indicators may change proportionally to the pressure response in the corresponding air bladders, providing immediate feedback on the cushion's adaptive behavior.

The visual representation may take various forms. In some embodiments, it may comprise a map including at least one indicator corresponding to each bladder of the plurality of bladders. This map may use color coding, numerical values, or other visual cues to represent the current state of each bladder. For example, bladders with higher pressure may be shown in darker colors, while those with lower pressure may be represented by lighter shades.

In some embodiments, the visual representation may comprise a map representing a shape or area of at least a portion of a seat that includes the cushion system. This map may provide a more holistic view of the entire seating surface, potentially using contour lines or heat map-style coloration to indicate pressure distribution across the seat.

In some embodiments, the initialization sequence may also involve displaying a model of the cushion or the seat on the user interface. The model may be a 3D model or map. The representation may visually demonstrate how the cushion shifts and conforms to the user's body. As the system adjusts, the model may show an increase in the apparent surface area of contact between the user and the cushion, as well as the user's body immersing deeper into the cushion surface.

In some embodiments, during the initialization process, the system may analyze pressure readings from various bladders to infer characteristics about the user. For instance, the system may detect lower than expected pressure in the thigh area, which could indicate a taller individual whose feet are firmly placed on the ground. In response, the system may increase pressure in the thigh bladders to provide better support. Conversely, if the system detects higher than expected pressure in the thigh area, it may infer that the user's legs are dangling. In this case, the system may slightly decrease pressure in the thigh bladders to alleviate potential discomfort. If the system detects higher than expected pressures in the middle region where bony prominences typically make contact, it may respond by increasing pressure in the back corner bladders. This adjustment may help redistribute the load and provide better support for the user's pelvic area. Conversely, if the system detects excessive pressure in the back corner bladders, it may infer that the user has a wider hip structure. In response, the system may slightly deflate these bladders to create a flatter, more accommodating surface that better distributes pressure across a larger area.

In some embodiments, the system may detect minimal pressure across most bladders but observe higher pressure readings in the back middle cells. This pressure pattern may suggest that the user is a child. The system may also use pressure distribution patterns to infer potential gender-based anatomical differences. For instance, certain pressure patterns may be more commonly associated with male or female users. While individual variations exist, these inferences may allow the system to select initial settings that are more likely to provide comfort for the user. These inferred user characteristics may influence how the system determines its static position settings. For example, the system may adjust the overall pressure distribution, the degree of contouring, and/or the relative pressure differences between various zones based on the inferred body type and size.

In some embodiments, these inferences may impact how the system performs dynamic adjustments such as weight shifts or pressure relief cycles. The magnitude, frequency, and pattern of these adjustments may be tailored based on the inferred user characteristics. For instance, the system may implement more gradual pressure changes for users inferred to have a smaller body frame, or it may focus pressure relief cycles on specific areas based on the detected pressure distribution patterns.

In some embodiments, the system may combine these pressure-based inferences with other data sources, such as user input or historical usage patterns, to further refine its adaptive responses. This multi-faceted approach may allow the cushion system to provide a more personalized and effective support experience for a wide range of users.

In some embodiments, the initialization sequence may also involve user interaction. In some implementations, the system may present a survey to gather user preferences, such as desired firmness levels or the degree of adaptive motion they prefer. Users may also have the option to manually adjust the baseline position of the cushion by selecting individual zones and fine-tuning them to their liking. By combining automated adjustments with user input, the initialization sequence may establish a personalized baseline configuration for the cushion system. This tailored setup may serve as a starting point for further dynamic adjustments during ongoing use, ensuring that the cushion provides optimal support and comfort for each individual user.

### 2.B. Flowcharts

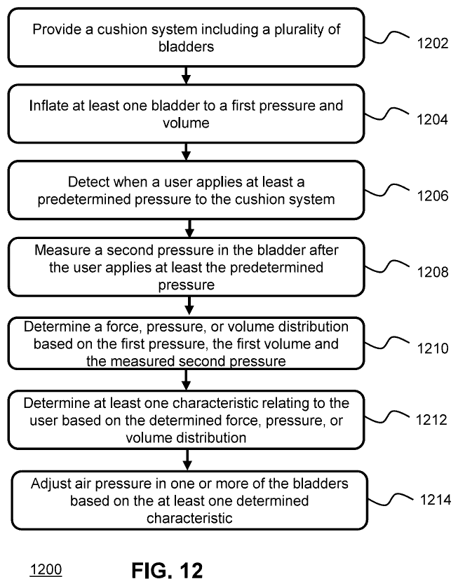

FIG. 12 depicts a method 1200 for initializing and adjusting a cushion system. The method includes several steps for setting up and customizing the cushion system based on user characteristics.

At step 1202, the method may involve providing a cushion system that includes a plurality of bladders. This step may encompass setting up the physical components of the cushion system, including the bladders, sensors, and control mechanisms.

At step 1204, at least one bladder of the plurality of bladders may be inflated to a first pressure and volume. This initial inflation may serve as a baseline state for the cushion system before user interaction.

At step 1206, the method may detect when a user applies at least a predetermined pressure to the cushion system. This detection may be accomplished through pressure sensors integrated into the cushion system or through monitoring changes in bladder pressure.

At step 1208, a second pressure in the at least one bladder may be measured after the user applies at least the predetermined pressure to the cushion system. This measurement may capture how the user's body weight and distribution affect the bladder pressure.

At step 1210, the method may determine a force, pressure, volume distribution based at least in part on the first pressure, the first volume, and the measured second pressure. This determination may involve calculations using the relationship between pressure and volume to infer how the user's weight is distributed across the cushion surface or across one or more bladders.

At step 1212, at least one characteristic relating to the user may be determined based on the determined force, pressure, or volume distribution. These characteristics may include factors such as body shape, weight distribution, or overall mass. The system may use algorithms or predefined models to interpret the force, pressure, or volume distribution data and infer user characteristics.

At step 1214, the method may adjust air pressure in one or more of the bladders based on the at least one determined characteristic. This adjustment may aim to optimize support and pressure distribution for the specific user. The system may increase pressure in some bladders while decreasing it in others to achieve the desired support profile.

The method 1200 may be implemented as part of an initialization sequence when a user first sits on the cushion, or it may be performed periodically during use to maintain optimal support. The steps may be executed in sequence as shown, or in some cases, certain steps may be performed in parallel or in a different order depending on the specific implementation of the cushion system.

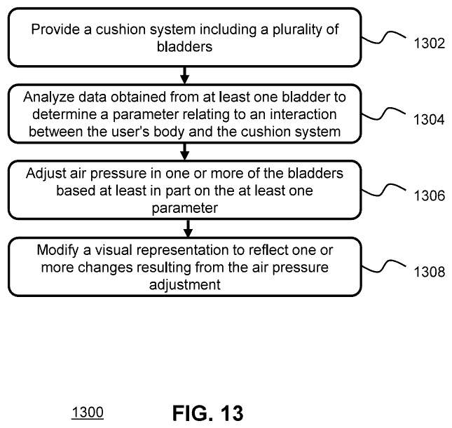

FIG. 13 depicts a method 1300 for managing a visual representation of a cushion system. The method includes several steps for analyzing user interaction data and updating the visual representation accordingly.

At step 1302, the method may involve providing a cushion system that includes a plurality of bladders. This step may encompass setting up the physical components of the cushion system, including the bladders, sensors, and control mechanisms.

At step 1304, the method may analyze data obtained from at least one of the plurality of bladders to determine at least one parameter relating to an interaction between the user's body and the cushion system. This analysis may involve processing pressure readings, volume changes, or other sensor data from the bladders to infer information about the user's position, weight distribution, or movement patterns.

At step 1306, the method may adjust air pressure in one or more of the bladders based at least in part on the at least one parameter. This adjustment may aim to optimize support, comfort, or pressure distribution for the user. The system may increase pressure in some bladders while decreasing it in others to achieve the desired support profile based on the analyzed interaction data.

At step 1308, the method may modify a visual representation to reflect one or more changes resulting from the air pressure adjustment. This modification may update the display to show the new pressure distribution, bladder inflation levels, or other relevant information. The visual representation may take various forms, such as a color-coded map of the bladders or a contour diagram of the seating surface.

The method 1300 may be implemented as part of an ongoing process to maintain optimal support and provide real-time feedback to the user. The steps may be executed in sequence as shown, or in some cases, certain steps may be performed in parallel or in a different order depending on the specific implementation of the cushion system and its user interface.

### 3. State Detection and Cushion Response for Cushion Systems

In some embodiments, the cushion system may adjust its operation based on the state of the seat or the activity state of the user. The state detection process may apply or use any of the features described with respect to FIGS. 1-11 or otherwise described herein.

### 3.A. State Detection and Cushion Response

In some embodiments, a cushion system may include a plurality of bladders, a first sensor configured to measure pressure in at least one of the plurality of bladders, and a second sensor configured to detect a position of the seat. The system may also include at least one controller configured to manage the state-based adjustments. In some embodiments, the controller may determine a first state of the seat based at least in part on data from the second sensor. This sensor may be, for example, an angle sensor, a position sensor, an accelerometer, an inertial measurement unit, a temperature sensor, an atmospheric pressure sensor, or a touch pressure sensor. The sensor may detect the seat's orientation or configuration or provide data that enables determination of the seat's positional state. The controller may then detect a transition from the first state to a second state based at least in part on data from the second sensor. Upon detecting this transition, the controller may determine a target pressure distribution for the second state and adjust the air pressure in one or more of the plurality of bladders to achieve the target pressure distribution.

In some embodiments, the seat frame supporting the cushion may have multiple adjustable surfaces, including the seat pan angle or height, leg rest angle, backrest angle, head rest angle, or armrest angle. By monitoring these positions, the system may infer where the ideal load should be supported on the occupant's body. For example, the amount of load supported by the back cushion may change significantly when a user transitions from sitting upright to a reclined sleeping position.

As shown in FIGS. 7-9, the cushion system may be incorporated into various seat configurations with multiple adjustable portions. FIG. 7 depicts a seat assembly with a seat cushion 720 and backrest cushion 740, both of which may incorporate bladder arrays (722 and 742 respectively) that can be individually adjusted based on the seat state. FIG. 8 illustrates a seat assembly with additional components such as a footrest cushion 860 with its own bladder array 862, allowing for more comprehensive body support across different seat positions. FIG. 9 shows a seat assembly where the lower cushion 920 and upper cushion 940, both containing bladder arrays (922 and 942), may be adjusted independently to accommodate different lying positions.

In some embodiments, the system may use inertial measurement units within the cushion itself to detect orientation changes. The air bladders may also be used to differentiate between side and back sleeping positions based on pressure distributions in different air cells. When back sleeping is detected, the system may adjust firmness to decrease pressure points created by the reduction in contact surface area. The cushion may also be programmed to perform different magnitudes or patterns of pressure shifts for different zones when the seat is in different positions. For instance, if the system detects that the backrest has been reclined, it may automatically adjust the lumbar support pressure based on the recline angle or the pressure it experiences, without requiring direct user interaction.

In some embodiments, the system may be configured to know when a vehicle (e.g., an airplane, a helicopter) is entering specific phases of operation, such as taxi, takeoff, or landing. This information may enable the cushion to move to a predetermined state, such as fully deflated or set to specific pressure or volume points, ensuring that the occupant is in a position where head height or eye level is known. This capability may be particularly relevant for aviation applications (among other applications).

In some embodiments, the system may include at least one controller configured to adjust the air pressure in at least one of the plurality of bladders to one of several states. In some embodiments, the system may fully deflate one or more bladders to a zero pressure state, which may be useful during certain phases of flight where a flatter seating surface is desired or when rapid evacuation might be necessary. In some embodiments, the system may allow pilots or other users to pre-select preferred pressure settings for different flight phases. For example, a pilot may choose a firmer setting for takeoff and landing, and a softer setting for cruising. In some embodiments, system may have pre-programmed pressure settings optimized for different flight phases based on ergonomic studies or safety considerations.

The adjustment to one of these states may be triggered by the detection or anticipation of a transition between vehicle operating phases. For instance, when the system detects a transition from taxiing to takeoff, it may automatically adjust the bladder pressures to the appropriate pre-selected or predetermined setting. In some embodiments, the system may anticipate transitions between operating phases by analyzing data from the vehicle's navigation systems, flight plans, or other predictive indicators, allowing the cushion to proactively adjust bladder pressures before the actual phase change occurs.

In some embodiments, the system may use various methods to detect phase transitions. It may interface with the vehicle's avionics system to receive direct input about the current flight phase. Alternatively, it may use onboard sensors such as accelerometers or pressure sensors to infer the current phase based on changes in motion or altitude.

The system may also incorporate safety features related to these phase-based adjustments. For example, during takeoff and landing, the system may prioritize settings that ensure proper posture and support, potentially overriding user preferences if they conflict with safety guidelines. In some embodiments, the system may allow for different adjustment profiles based on the type of flight or mission. For instance, a commercial flight may have a different set of adjustments compared to a military transport mission.

The ability to adjust bladder pressures based on flight phases may enhance both comfort and safety. It may help maintain proper posture during critical phases of flight, reduce fatigue during long flights, and ensure that the seating configuration is optimal for each stage of the journey.

In some embodiments, the system may also incorporate user activity detection. For example, if someone is sleeping, the system may identify reduced motion through the air bladders and pause adjustments to avoid disturbing the passenger. The system may also use pressure readings to infer other user states or characteristics, allowing for more personalized comfort settings.

In some embodiments, the cushion system may interface with other vehicle or environmental systems. For example, if the system knows when meals are being served, when the vehicle is landing, or has a wake-up time set by the passenger, it could initiate gentle movements to wake the passenger or prepare them for the upcoming activity. By continuously monitoring and adapting to both seat state and user activity, the cushion system may provide a dynamic and responsive support surface that enhances user comfort across a wide range of seating scenarios and user preferences.

### 3.B. Flowchart

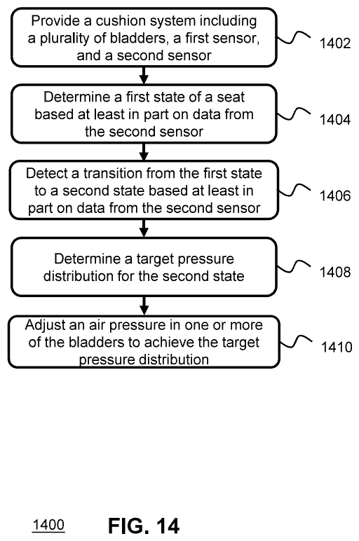

FIG. 14 depicts a method 1400 FIG. 14 depicts a method 1400 for operating a cushion system. The method 1400 includes several steps for managing the cushion system based on seat or user state and sensor data.

At step 1402, the method may involve providing a cushion system that includes a plurality of bladders, a first sensor, and a second sensor. The plurality of bladders may be arranged in various configurations within the cushion to provide support for different body areas. The first sensor may be configured to measure pressure in at least one of the plurality of bladders, while the second sensor may be configured to detect a position of the seat. In some aspects, the second sensor may be an angle sensor, a position sensor, an accelerometer, an inertial measurement unit, a temperature sensor, an atmospheric pressure sensor, or a touch pressure sensor.

At step 1404, the method may determine a first state of the seat based at least in part on data from the second sensor. This determination may involve processing the sensor data to identify the current configuration or orientation of the seat. For example, the system may determine whether the seat (or any portion thereof) is in an upright position, a reclined position, or any intermediate state.

At step 1406, the method may detect a transition from the first state to a second state based at least in part on data from the second sensor. This detection may involve continuous monitoring of the sensor data to identify changes in the seat's position or configuration. The transition may be triggered by user-initiated adjustments, automated seat movements, or changes in vehicle operating conditions.

At step 1408, the method may determine a target pressure distribution for the second state. This determination may take into account various factors such as the new seat position, user preferences, ergonomic considerations, or pre-programmed settings for specific seat states or vehicle operating phases. The target pressure distribution may aim to optimize support, comfort, and safety for the user in the new seat state.

At step 1410, the method may adjust an air pressure in one or more of the plurality of bladders to achieve the target pressure distribution. This adjustment may involve selectively inflating or deflating specific bladders or groups of bladders to redistribute pressure across the cushion surface. The adjustment may be performed gradually to ensure a smooth transition for the user.

The method 1400 may be implemented as a continuous process, with the system constantly monitoring for state changes and adjusting bladder pressures as needed. In some implementations, the method may also incorporate feedback from the first sensor to fine-tune pressure adjustments based on actual pressure readings from the bladders.

This method allows the cushion system to dynamically adapt to changes in seat state, providing optimal support and comfort for the user across various seating scenarios and conditions. The adaptive nature of the system may enhance user experience in different applications, such as office seating, vehicle seating, or medical support surfaces.

### 4. Impact and Vibration Mitigation for Cushion Systems

In some embodiments, the cushion system may adjust its operation to mitigate vibration and absorb impacts based on detected vibrations or anticipated impacts. The vibration and impact mitigation process may apply or use any of the features described with respect to FIGS. 1-11 or otherwise described herein.

### 4.A. Impact and Vibration Mitigation

In some embodiments, the cushion system may incorporate features for mitigating vibration and absorbing impacts. The system may include a plurality of bladders that can be individually controlled to adjust pressure distribution and support. In some embodiments, these bladders may be made of elastic materials that allow for volume expansion when there is a sudden increase in pressure.

In some embodiments, the cushion system may include at least one valve associated with the bladders. In some embodiments, these valves may include at least one passive relief valve configured to vent air from at least one of the plurality of bladders when a pressure within the at least one bladder exceeds a predetermined threshold. This passive relief mechanism may allow for automatic pressure release during sudden impacts or pressure spikes.

In some embodiments, the system may include at least one actively controlled valve configured to selectively adjust air flow into or out of at least one of the plurality of bladders. These actively controlled valves may be managed by at least one controller, which may adjust the state of the valves based on various inputs. The controller may adjust the state of the actively controlled valves based on the detection of various events or effects.

In some embodiments, the valves may be positioned in various locations within the cushion system. The valves may be located within one or more of the bladders themselves, providing localized control of air flow. In some cases, the valves may be integrated into other parts of the cushion, such as the cushion support. Alternatively, the valves may be positioned external to the cushion while maintaining fluid connection to the bladders. This external configuration may allow for more flexible placement of valve components and easier maintenance or replacement. The system may utilize a combination of valve placements, with some valves located within the cushion and others positioned externally, depending on the specific design requirements and intended functionality of the cushion system.

In some embodiments, the bladders and/or valves may be positioned within a backrest and/or a seat portion of a seat. While the system may be implemented in various locations, use of the bladders and/or valves in the seat cushion portion may be particularly useful in aircraft applications where rapid decompression protection is key. For instance, the cushion in the seat bottom may incorporate specialized pressure relief or blowout capabilities to mitigate risks associated with sudden pressure changes during flight. The impact absorption features may also prove valuable in other vehicular contexts. In automotive applications, for example, the use of a cushion system in the backrest portion may help protect occupants during rear-end collisions by absorbing and distributing impact forces through controlled air release or redistribution. This adaptability allows the cushion system to provide safety benefits across various transportation modes, addressing different types of potential impacts or pressure events.

In some embodiments, the controller may adjust the state of the actively controlled valves based on the detection of at least one vibration. This vibration detection may be accomplished through various means, such as analyzing pressure data from the bladders themselves or using dedicated sensors like accelerometers. When vibrations are detected, the system may adjust bladder pressures to dampen these vibrations and enhance user comfort.

In some embodiments, the cushion system may incorporate accelerometers to detect vibrations. These accelerometers may be strategically placed within the cushion structure, such as in or near the support of the cushion or integrated into the bladder arrays. The accelerometers may provide real-time data on the magnitude and frequency of vibrations experienced by the cushion system. In some embodiments, multiple accelerometers may be used to detect vibrations in different axes, allowing for a more comprehensive analysis of the vibration patterns.

In some embodiments, the system may analyze data from the bladders to detect vibrations by examining the noise patterns in the pressure readings. This analysis may involve applying signal processing techniques to the pressure data streams from individual bladders or groups of bladders. In some embodiments, the system may use Fourier transforms to convert the time-domain pressure data into frequency-domain representations, allowing for the identification of specific vibration frequencies. The system may also employ filtering techniques to isolate relevant frequency ranges and remove background noise.

In some embodiments, the cushion system may implement an iterative process for vibration mitigation. For example, the system may include one or more of the following steps. The system may detect a first vibration using data from the accelerometers or bladder pressure readings. This initial vibration may be characterized by its frequency, amplitude, and duration. Based on the characteristics of the first vibration, the system may adjust a setting of the cushion system. This adjustment may involve changing the air pressure in one or more bladders, modifying the stiffness of certain cushion zones, or altering the overall pressure distribution across the cushion surface. After implementing the adjustment, the system may detect a second vibration. This second vibration may be measured using the same methods as the first vibration, allowing for a direct comparison. The system may then evaluate one or more changes in the second vibration relative to the first vibration. This evaluation may include comparing the amplitude, frequency, or duration of the vibrations. The system may also assess how the vibration energy is distributed across different frequency bands or cushion zones. Based on this evaluation, the system may determine whether the second vibration or the observed changes meet a target threshold. This threshold may be defined in terms of vibration reduction, user comfort metrics, or other relevant parameters. If the target threshold is not met, the system may iteratively adjust the cushion settings and detect subsequent vibrations. Each iteration may involve fine-tuning the previous adjustment or trying a different approach based on the observed results.

In some embodiments, this iterative process may continue until the target threshold is met, indicating that the vibration has been sufficiently mitigated. In some embodiments, the system may employ machine learning algorithms to optimize this process over time, learning from past adjustments and their effectiveness in reducing vibrations. The system may also consider user preferences and comfort levels when making these iterative adjustments. For example, some users may prefer a firmer cushion even if it transmits slightly more vibration, while others may prioritize maximum vibration dampening. The iterative process may take these preferences into account when determining the optimal settings for vibration mitigation.

In some embodiments, the controller may also adjust valve states based on the detection of an anticipated impact of the vehicle. This anticipatory function may allow the system to prepare for impacts before they occur, improving impact absorption and user protection. The cushion system may incorporate various methods to anticipate impacts and prepare for them proactively. These anticipatory functions may enhance the system's ability to protect users and absorb impact energy effectively.

In some embodiments, the system may utilize vibration monitoring as one approach to anticipate potential impacts. By analyzing the frequency, amplitude, and patterns of vibrations detected through accelerometers or pressure sensors in the bladders, the system may identify signatures that precede certain types of impacts. For example, in a vehicle application, the system may learn to recognize vibration patterns associated with sudden braking, sharp turns, or rough road conditions that could lead to impacts.

In some embodiments, the cushion system may interface with the vehicle's onboard systems to receive direct input about potential impact scenarios. This may include data from the vehicle's collision avoidance systems, stability control systems, or navigation systems. For instance, if the vehicle's forward-facing sensors detect an imminent collision, this information may be relayed to the cushion system, allowing it to prepare for the anticipated impact.

In some embodiments, the system may also incorporate external sensors, such as cameras or LIDAR, to monitor the surrounding environment. These sensors may provide additional data to help predict potential impacts, such as detecting obstacles in the vehicle's path or monitoring the behavior of nearby vehicles. In some embodiments, the cushion system may use machine learning algorithms to improve its impact prediction capabilities over time. By analyzing historical data on vibrations, vehicle movements, and actual impact events, the system may refine its ability to anticipate impacts based on subtle precursor signals.

When an impact is anticipated, the system may take one or more of numerous preemptive actions. It may adjust the pressure distribution across the bladders to optimize impact absorption. For example, it may increase pressure in certain areas to create a firmer, more protective surface, while decreasing pressure in others to allow for controlled deformation during impact. The system may also pre-position the user by adjusting bladder pressures to guide them into a safer posture. This may involve slightly raising or lowering certain body parts, or adjusting the overall seat angle to minimize the risk of injury during impact.

In some embodiments, the system may activate rapid inflation or deflation sequences in specific bladders just before an anticipated impact. This dynamic response may help to create a more effective energy-absorbing structure at the moment of impact.

By combining these various methods of impact anticipation and proactive response, the cushion system may significantly enhance its ability to protect users and mitigate the effects of impacts across a wide range of scenarios.

For example, as illustrated in FIG. 10, a conventional cushion system may have limited capacity to absorb and distribute impact forces. When an impact occurs, a significant portion of the energy may be transferred directly to the user, potentially leading to increased spinal loading and discomfort. In contrast, FIG. 11 demonstrates how the improved cushion system with air bladders may respond to an impact event. The bladders, made with elastic materials, may expand and contract in response to pressure changes. During an impact, the air bladders may vent air, allowing for controlled deformation and energy absorption. This controlled collapse may extend the duration of the impact event, reducing peak forces experienced by the user and distributing the impact force over a larger area.

In some embodiments, the system may also be programmed to perform different magnitudes or patterns of pressure shifts for different zones when the seat is in different positions. For instance, if the system detects that the backrest has been reclined, it may automatically adjust the lumbar support pressure based on the recline angle or the pressure it experiences.

In some embodiments, the cushion system may interface with other vehicle systems to anticipate impacts or changes in operating conditions. For example, the system may be configured to adjust its state based on specific phases of vehicle operation, such as taxi, takeoff, or landing in an airplane.

By combining passive relief valves, actively controlled valves, and intelligent pressure management, the cushion system may provide enhanced vibration mitigation and impact absorption, improving user comfort and safety across a wide range of seating scenarios and operating conditions.

In some embodiments, the cushion system may include additional or alternative relief mechanisms. For example, in some embodiments, at least one bladder of the air bladders 420 may include one or more portions or regions that are structurally modified relative to one or more other portions or regions of the bladder. This structurally modified portion may be configured to rupture in a controlled manner when subjected to a predetermined pressure, allowing air to vent at a predetermined rate through the resulting opening in the at least one bladder.

In some embodiments, the structurally modified portion may incorporate a region designed to exhibit controlled deformation or separation under specific pressure conditions. This region may be engineered with precise material properties, thickness variations, or geometric features that allow it to predictably yield when subjected to predetermined stress levels. The design of this region may take into account factors such as material elasticity, stress concentration patterns, and desired failure modes to achieve a specific air venting behavior. In some embodiments, the structurally modified region may be created through techniques such as selective thinning, introduction of micro-perforations, or integration of materials with different mechanical properties. This approach may allow for fine-tuned control over the pressure threshold at which air release occurs and the subsequent rate of air venting. The integration of structurally modified portions in select (or all of the) bladders may provide an additional or alternative degree of customization and adaptability to the cushion system, allowing it to respond dynamically to extreme pressure conditions while maintaining its primary support and comfort functions under normal use.

### 4.B. Flowchart

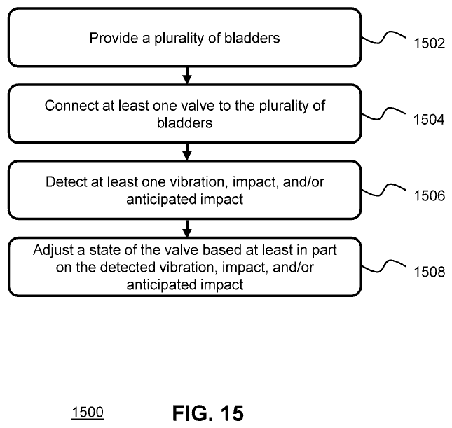

FIG. 15 depicts a method 1500 for FIG. 15 depicts a method 1500 for operating a cushion system with vibration and impact mitigation capabilities. The method includes several steps for managing the cushion system's response to detected vibrations, impacts, or anticipated impacts.

At step 1502, the method may involve providing a plurality of bladders. These bladders may be arranged in various configurations within the cushion system to provide support and pressure distribution for different body areas. The bladders may be made of elastic materials that allow for volume expansion and contraction in response to pressure changes.

At step 1504, at least one valve may be connected to the plurality of bladders. This valve may include passive relief valves, actively controlled valves, or a combination of both. The valve may be configured to selectively adjust air flow into or out of at least one of the plurality of bladders. In some embodiments, the valve may be positioned within the cushion itself, while in other embodiments, it may be located external to the cushion while maintaining fluid connection to the bladders.

At step 1506, the method may involve detecting at least one vibration, impact, and/or anticipated impact. This detection may be accomplished through various means. In some cases, the system may analyze pressure data from the bladders themselves to detect vibrations or impacts. In other implementations, dedicated sensors such as accelerometers or inertial measurement units may be used to detect vibrations or anticipate impacts. The system may also interface with vehicle systems to receive information about potential impact scenarios.

At step 1508, the method may adjust a state of the valve based at least in part on the detected vibration, impact, and/or anticipated impact. This adjustment modifies the air flow into or out of at least one of the plurality of bladders. For vibration mitigation, the system may adjust bladder pressures to dampen detected vibrations and enhance user comfort. In the case of impacts or anticipated impacts, the system may rapidly adjust bladder pressures to create a more effective energy-absorbing structure. This may involve increasing pressure in certain areas to create a firmer, more protective surface, while decreasing pressure in others to allow for controlled deformation during impact.

In some embodiments, the method 1500 may be executed continuously or at regular intervals to provide ongoing vibration and impact mitigation. The system may also employ machine learning algorithms to improve its response capabilities over time, learning from past adjustments and their effectiveness in reducing vibrations or mitigating impacts.

The method 1500 may be particularly valuable in various applications, including aircraft seating where protection against rapid decompression is crucial, and automotive seating where impact absorption during collisions is important. By dynamically adjusting bladder pressures in response to detected conditions, the cushion system may enhance user comfort and safety across a wide range of scenarios.

### 5. Computer System

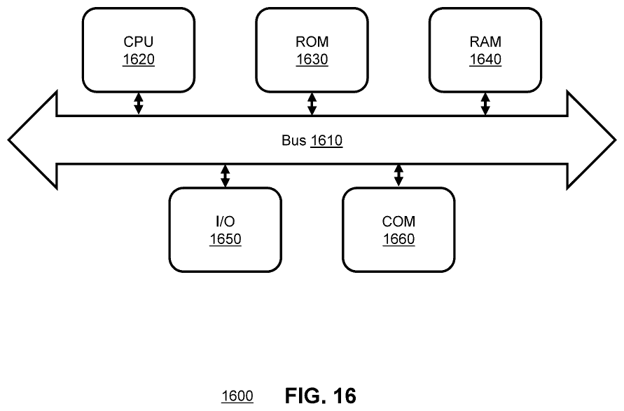

FIG. 16 depicts an example system that may execute techniques presented herein. FIG. 16 is a simplified functional block diagram of a computer that may be configured to execute techniques described herein, according to exemplary cases of the present disclosure. Specifically, the computer (or “platform” as it may not be a single physical computer infrastructure) may include a data communication interface 1660 for packet data communication. The platform may also include a central processing unit 1620 (“CPU 1620”), in the form of one or more processors, for executing program instructions. The platform may include an internal communication bus 1610, and the platform may also include a program storage and/or a data storage for various data files to be processed and/or communicated by the platform such as ROM 1630 and RAM 1640, although the system 1600 may receive programming and data via network communications. The system 1600 also may include input and output ports 1650 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### 6. Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “in-ear” in some cases refers to being on or attached to the ear of a subject. As used herein, the term “in-ear” in some cases refers to being inside the concha of the ear of a subject. As used herein, the term “in-ear” in some cases refers to being inside an ear canal of the subject.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “substantially,” “generally,” and “approximately” are used to indicate a possible variation of ±10% in a stated value.

The term “exemplary” is used in the sense of “example” rather than “ideal.”

### 7. Examples

Exemplary embodiments of the systems and methods disclosed herein are described in the numbered paragraphs below.
A1. A cushion system, comprising:
   a plurality of bladders;
   at least one sensor configured to detect when a user applies at least a predetermined pressure to the cushion system;
   at least one controller configured to:
      inflate at least one bladder of the plurality of bladders to a first pressure and volume;
      measure a second pressure in the at least one bladder after the user applies at least the predetermined pressure to the cushion system;
      determine a force, pressure, or volume distribution based at least in part on the first pressure, the first volume, and the measured second pressure;
      determine at least one characteristic relating to the user based on the determined force, pressure, or volume distribution; and
      adjust an air pressure in one or more of the bladders based on the at least one determined characteristic.
A2. The cushion system of A1, wherein the at least one characteristic comprises at least one of: body shape, weight distribution, posture, or body size.
A3. The cushion system of any of A1-A2, further comprising a memory configured to store historical pressure or volume data for the plurality of bladders.
A4. The cushion system of any of A1-A3, further comprising a user interface configured to receive user input for customizing pressure settings in different zones of the cushion system.
A5. The cushion system of any of A1-A4, wherein the system is further configured to (i) display a visual representation of the cushion system to the user and (ii) update the visual representation to reflect one or more changes to the cushion system during use.
A6. The cushion system of A5, wherein the at least one controller is further configured to:
   analyze data obtained from at least one of the plurality of bladders to determine at least one parameter relating to an interaction between the user's body and the cushion system;
   adjust air pressure in one or more of the bladders based at least in part on the at least one parameter;
   modify the visual representation to reflect one or more changes resulting from the air pressure adjustment.
A7. The cushion system of A5, wherein the visual representation comprises at least one of:
   a map including at least one indicator corresponding to each bladder of the plurality of bladders; or
   a map representing a shape or area of at least a portion of a seat that includes the cushion system.
A8. A method of using a cushion system, comprising:
   providing a cushion system, wherein the cushion system comprises a plurality of bladders;
   inflating at least one bladder of the plurality of bladders to a first pressure and volume;
   detecting when a user applies at least a predetermined pressure to the cushion system;
   measuring a second pressure in the at least one bladder after the user applies at least the predetermined pressure to the cushion system;
   determining a force, pressure, or volume distribution based at least in part on the first pressure, the first volume, and the measured second pressure;
   determining at least one characteristic relating to the user based on the determined force, pressure, or volume distribution; and
   adjusting air pressure in one or more of the bladders based on the at least one determined characteristic.
A9. The method of A8, wherein the at least one characteristic comprises at least one of: body shape, weight distribution, posture, or body size.
A10. The method of any of A8-A10, further comprising storing historical pressure or volume data for the plurality of bladders in a memory.
A11. The method of any of A8-A11, further comprising receiving user input through a user interface for customizing pressure settings in different zones of the cushion system.
A12. The method of any of A8-A11, further comprising (i) presenting a visual representation of the cushion system to the user and (ii) updating the visual representation to reflect one or more changes to the cushion system during use.
A13. The method of A12, further comprising:
   analyzing data obtained from at least one of the plurality of bladders to determine at least one parameter relating to an interaction between the user's body and the cushion system;
   adjusting air pressure in one or more of the bladders based at least in part on the at least one parameter; and
   modifying the visual representation to reflect one or more changes resulting from the air pressure adjustment.
A14. The method of A12, wherein the visual representation comprises at least one of:
   a map including at least one indicator corresponding to each bladder of the plurality of bladders; or
   a map representing a shape or area of at least a portion of a seat that includes the cushion system.
A15. A cushion system, comprising:
   a plurality of bladders; and
   at least one controller;
   wherein the system is configured to (i) display a visual representation of the cushion system to a user and (ii) update the visual representation based at least in part on one or more changes to the cushion system during use; and
   wherein the controller is configured to:
      analyze data obtained from at least one of the plurality of bladders to determine at least one parameter relating to an interaction between the user's body and the cushion system;
      adjust air pressure in one or more of the bladders based at least in part on the at least one parameter; and
      modify the visual representation to reflect one or more changes resulting from the air pressure adjustment.
A16. The cushion system of A15, wherein the visual representation comprises a map including at least one indicator corresponding to each bladder of the plurality of bladders
A17. The cushion system of any of A15-A16, wherein the at least one controller is further configured to receive user input to manually adjust air pressure in one or more of the bladders.
A18. The cushion system of any of A15-A17, wherein analyzing data obtained from at least one of the plurality of bladders comprises comparing pressure readings from multiple bladders to determine weight distribution of the user.
A19. The cushion system of any of A15-A18, wherein the visual representation includes a map representing a shape or area of at least a portion of a seat that includes the cushion system.
A20. The cushion system of any of A15-A19, wherein the at least one controller is further configured to:
   inflate at least one bladder of the plurality of bladders to a first pressure and volume;
   measure a second pressure in the at least one bladder after the user applies at least a predetermined pressure to the cushion system;
   calculate a second volume for the at least one bladder based on the first pressure and volume and the measured second pressure;
   determine at least one characteristic relating to the user based on the calculated second volume; and
   adjust air pressure in one or more of the bladders based on the at least one determined characteristic.
B1. A cushion system for a seat, comprising:
   a plurality of bladders;
   a first sensor configured to measure pressure in at least one of the plurality of bladders;
   a second sensor configured to detect a position of the seat;
   at least one controller configured to:
      determine a first state of the seat based at least in part on data from the second sensor;
      detect a transition from the first state to a second state based at least in part on data from the second sensor;
      determine a target pressure distribution for the second state; and
      adjust an air pressure in one or more of the plurality of bladders to achieve the target pressure distribution.
B2. The cushion system of B1, wherein the second sensor comprises at least one of an angle sensor, a position sensor, an accelerometer, an inertial measurement unit, a temperature sensor, an atmospheric pressure sensor, or a touch pressure sensor.
B3. The cushion system of any of B1-B2, wherein the at least one controller is further configured to:
   determine an activity state of a user based at least in part on pressure data from the first sensor;
   adjust an air pressure in one or more of the plurality of bladders based at least in part on the determined activity state.
B4. The cushion system of B3, wherein determining the activity state of the user comprises determining that the user is in a sleeping state, and wherein the at least one controller is further configured to:
   reduce motion of one or more of the bladders based at least in part on determining that the user is in the sleeping state.
B5. The cushion system of B3, wherein the at least one controller is further configured to:
   determine that the user has been in the activity state for longer than a predetermined duration of time;
   generate a recommended action for the user to perform based on the determination that the user has been in the activity state for longer than the predetermined duration of time.
B6. The cushion system of any of B1-B5, wherein the at least one controller is further configured to generate a notification to indicate the state of the seat.
B7. The cushion system of any of B1-B6, wherein the seat comprises a plurality of sections, and wherein determining a state of the seat comprises determining a state of two or more of the plurality of sections.
B8. The cushion system of any of B1-B7, wherein the seat is a vehicle seat, wherein the at least one controller is further configured to adjust the cushion system to a predetermined state based at least in part on detection or anticipation of a transition between a first vehicle operating phase and a second vehicle operating phase.
B9. The cushion system of B8, wherein the at least one controller is further configured to adjust the air pressure in at least one of the plurality of bladders to one of:
   a zero pressure state;
   a pressure setting selected by a user; or
   a predetermined pressure setting;
   wherein the adjustment is based at least in part on the detection or anticipation of the transition between the first vehicle operating phase and the second vehicle operating phase.
B10. The cushion system of any of B1-B9, wherein the at least one controller is further configured to:
   detect at least one vibration based at least in part on data obtained from the first or second sensor; and
   adjust an air pressure within at least one of the plurality of bladders based at least in part on the detected at least one vibration.
B11. A method of using a cushion system for a seat, comprising:
   providing a cushion system, the cushion system comprising:
      a plurality of bladders;
      a first sensor configured to measure pressure in at least one of the plurality of bladders; and
      a second sensor configured to detect a position of the seat;
   determining a first state of the seat based at least in part on data from the second sensor;
   detecting a transition from the first state to a second state based at least in part on data from the second sensor;
   determining a target pressure distribution for the second state; and
   adjusting an air pressure in one or more of the plurality of bladders to achieve the target pressure distribution.
B12. The method of B11, wherein the second sensor comprises at least one of an angle sensor, a position sensor, an accelerometer, an inertial measurement unit, a temperature sensor, an atmospheric pressure sensor, or a touch pressure sensor.
B13. The method of any of B11-B12, further comprising:
   determining an activity state of a user based at least in part on pressure data from the first sensor;
   adjusting an air pressure in one or more of the plurality of bladders based at least in part on the determined activity state.
B14. The method of B13, wherein determining the activity state of the user comprises determining that the user is in a sleeping state, and the method further comprises:
   reducing motion of one or more of the bladders based at least in part on determining that the user is in the sleeping state.
B15. The method of B13, further comprising:
   determining that the user has been in the activity state for longer than a predetermined duration of time;
   generating a recommended action for the user to perform based on the determination that the user has been in the activity state for longer than the predetermined duration of time.
B16. The method of any of B11-B15, further comprising generating a notification to indicate the state of the seat.
B17. The method of any of B11-B16, wherein the seat comprises a plurality of sections, and wherein determining a state of the seat comprises determining a state of two or more of the plurality of sections.
B18. The method of any of B11-B17, wherein the seat is a vehicle seat, and the method further comprises adjusting the cushion system to a predetermined state based at least in part on detection or anticipation of a transition between a first vehicle operating phase and a second vehicle operating phase.
B19. The method of B18, wherein at least one controller is further configured to adjust the air pressure in at least one of the plurality of bladders to one of:
   a zero pressure state;
   a pressure setting selected by a user; or
   a predetermined pressure setting;
   wherein the adjustment is based at least in part on the detection or anticipation of the transition between the first vehicle operating phase and the second vehicle operating phase.
B20. The method of any of B11-B19, further comprising: detecting at least one vibration based at least in part on data obtained from the first or second sensor; and
   adjusting an air pressure within at least one of the plurality of bladders based at least in part on the detected at least one vibration.
C1. A cushion system for a seat of a vehicle, comprising:
   a plurality of bladders;
   at least one valve connected to the plurality of bladders, wherein the at least one valve includes at least one actively controlled valve configured to selectively adjust air flow into or out of at least one of the plurality of bladders; and
   at least one controller configured to:
      adjust a state of the at least one actively controlled valve based at least in part on:
         detection of at least one vibration; or
         detection of an anticipated impact of the vehicle.
C2. The cushion system of C1, further comprising at least one passive relief valve configured to vent air from at least one of the plurality of bladders when a pressure within the at least one bladder exceeds a predetermined threshold.
C3. The cushion system of any of C1-C2, wherein the at least one controller is further configured to:
   detect at least one vibration based at least in part on data obtained from the plurality of bladders; and
   adjust an air pressure within at least one of the plurality of bladders based at least in part on the detected at least one vibration.
C4. The cushion system of C3, wherein the at least one controller is further configured to analyze one or more noise patterns in the air pressure data to detect the at least one vibration.
C5. The cushion system of any of C1-C4, wherein the at least one controller is further configured to:
   detect the at least one vibration based at least in part on data obtained from at least one sensor; and
   adjust an air pressure within at least one of the plurality of bladders based at least in part on the detected at least one vibration.
C6. The cushion system of any of C1-C5, wherein the seat comprises a seat portion and a backrest portion and wherein at least one bladder of the plurality of bladders is located in the seat portion.
C7. The cushion system of any of C1-C6, wherein the at least one controller is further configured to:
   detect a first vibration;
   adjust a setting of the cushion system based at least in part on the first vibration;
   detect a second vibration after adjusting the setting;
   evaluate one or more changes in the second vibration relative to the first vibration;
   determine whether the second vibration or the one or more changes meet a target threshold; and
   iteratively adjust the setting and detect further subsequent vibrations until the target threshold is met.
C8. The cushion system of any of C1-C7, wherein the at least one controller is further configured to:
   receive a signal indicating an anticipated impact of the vehicle;
   selectively adjust a state of the at least one actively controlled valve based at least in part on the received signal; and
   modify a pressure distribution within the plurality of bladders to enhance impact absorption or adjust a position of a user.
C9. A method of using a cushion system for a seat of a vehicle, the method comprising:
   providing a plurality of bladders;
   connecting at least one valve to the plurality of bladders, wherein the at least one valve includes at least one actively controlled valve configured to selectively adjust air flow into or out of at least one of the plurality of bladders;
   adjusting, by at least one controller, a state of the at least one actively controlled valve based at least in part on:
      detection of at least one vibration; or
      detection of an anticipated impact of the vehicle.
C10. The method of C9, further comprising connecting at least one passive relief valve to the plurality of bladders, wherein the at least one passive relief valve is configured to vent air from at least one of the plurality of bladders when a pressure within the at least one bladder exceeds a predetermined threshold.
C11. The method of any of C9-C10, further comprising: detecting at least one vibration based at least in part on data obtained from the plurality of bladders; and
   adjusting an air pressure within at least one of the plurality of bladders based at least in part on the detected at least one vibration.
C12. The method of C11, further comprising analyzing, by the at least one controller, one or more noise patterns in the air pressure data to detect the at least one vibration.
C13. The method of any of C9-C12, further comprising:
   detecting the at least one vibration based at least in part on data obtained from at least one sensor; and
   adjusting an air pressure within at least one of the plurality of bladders based at least in part on the detected at least one vibration.
C14. The method of any of C9-C13, wherein the seat comprises a seat portion and a backrest portion and wherein at least one bladder of the plurality of bladders is located in the seat portion.
C15. The method of any of C9-C14, further comprising:
   detecting a first vibration;
   adjusting a setting of the cushion system based at least in part on the first vibration;
   detecting a second vibration after adjusting the setting;
   evaluating one or more changes in the second vibration relative to the first vibration;
   determining whether the second vibration or the one or more changes meet a target threshold; and
   iteratively adjusting the setting and detecting further subsequent vibrations until the target threshold is met.
C16. The method of any of C9-C15, further comprising:
   receiving a signal indicating an anticipated impact of the vehicle;
   selectively adjusting a state of the at least one actively controlled valve based at least in part on the received signal; and
   modifying a pressure distribution within the plurality of bladders to enhance impact absorption or adjust a position of a user.
C17. A cushion system for a seat, comprising:
   a plurality of bladders, wherein each of the plurality of bladders is made at least partially of an elastic material;
   wherein the cushion system comprises at least one of the following features:
      (i) at least one passive relief valve configured to vent air from at least one of the plurality of bladders when a pressure within the at least one bladder exceeds a predetermined threshold; or
      (ii) at least one bladder of the plurality of bladders includes a portion that is structurally modified relative to one or more other portions of the at least one bladder, wherein the structurally modified portion is configured to rupture in a controlled manner when subjected to a predetermined pressure such that air vents at a predetermined rate through the resulting opening in the at least one bladder.
C18. The cushion system of C17, wherein the cushion system comprises the at least one passive relief valve.
C19. The cushion system of any of C17-C18, wherein the cushion system comprises the structurally modified portion.
C20. The cushion system of any of C17-C19, further comprising:
   at least one actively controlled valve configured to selectively adjust air flow into or out of at least one of the plurality of bladders; and
   at least one controller configured to adjust a state of the at least one actively controlled valve.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cushion system for a seat of a vehicle, comprising:
a plurality of bladders;
at least one valve connected to the plurality of bladders, wherein the at least one valve includes at least one actively controlled valve configured to selectively adjust air flow into or out of at least one of the plurality of bladders; and
at least one controller configured to:
adjust a state of the at least one actively controlled valve based at least in part on:
detection of at least one vibration; or
detection of an anticipated impact of the vehicle.

2. The cushion system of claim 1, further comprising at least one passive relief valve configured to vent air from at least one of the plurality of bladders when a pressure within the at least one bladder exceeds a predetermined threshold.

3. The cushion system of claim 1, wherein the at least one controller is further configured to:
detect at least one vibration based at least in part on data obtained from the plurality of bladders; and
adjust an air pressure within at least one of the plurality of bladders based at least in part on the detected at least one vibration.

4. The cushion system of claim 3, wherein the at least one controller is further configured to analyze one or more noise patterns in the air pressure data to detect the at least one vibration.

5. The cushion system of claim 1, wherein the at least one controller is further configured to:
detect the at least one vibration based at least in part on data obtained from at least one sensor; and
adjust an air pressure within at least one of the plurality of bladders based at least in part on the detected at least one vibration.

6. The cushion system of claim 1, wherein the seat comprises a seat portion and a backrest portion and wherein at least one bladder of the plurality of bladders is located in the seat portion.

7. The cushion system of claim 1, wherein the at least one controller is further configured to:
detect a first vibration;
adjust a setting of the cushion system based at least in part on the first vibration;
detect a second vibration after adjusting the setting;
evaluate one or more changes in the second vibration relative to the first vibration;
determine whether the second vibration or the one or more changes meet a target threshold; and
iteratively adjust the setting and detect further subsequent vibrations until the target threshold is met.

8. The cushion system of claim 1, wherein the at least one controller is further configured to:
receive a signal indicating an anticipated impact of the vehicle;
selectively adjust a state of the at least one actively controlled valve based at least in part on the received signal; and
modify a pressure distribution within the plurality of bladders to enhance impact absorption or adjust a position of a user.

9. A method of using a cushion system for a seat of a vehicle, the method comprising:
providing a plurality of bladders;
connecting at least one valve to the plurality of bladders, wherein the at least one valve includes at least one actively controlled valve configured to selectively adjust air flow into or out of at least one of the plurality of bladders;
adjusting, by at least one controller, a state of the at least one actively controlled valve based at least in part on:
detection of at least one vibration; or
detection of an anticipated impact of the vehicle.

10. The method of claim 9, further comprising connecting at least one passive relief valve to the plurality of bladders, wherein the at least one passive relief valve is configured to vent air from at least one of the plurality of bladders when a pressure within the at least one bladder exceeds a predetermined threshold.

11. The method of claim 9, further comprising:
detecting at least one vibration based at least in part on data obtained from the plurality of bladders; and
adjusting an air pressure within at least one of the plurality of bladders based at least in part on the detected at least one vibration.

12. The method of claim 11, further comprising analyzing, by the at least one controller, one or more noise patterns in the air pressure data to detect the at least one vibration.

13. The method of claim 9, further comprising:
detecting the at least one vibration based at least in part on data obtained from at least one sensor; and
adjusting an air pressure within at least one of the plurality of bladders based at least in part on the detected at least one vibration.

14. The method of claim 9, wherein the seat comprises a seat portion and a backrest portion and wherein at least one bladder of the plurality of bladders is located in the seat portion.

15. The method of claim 9, further comprising:
detecting a first vibration;
adjusting a setting of the cushion system based at least in part on the first vibration;
detecting a second vibration after adjusting the setting;
evaluating one or more changes in the second vibration relative to the first vibration;
determining whether the second vibration or the one or more changes meet a target threshold; and
iteratively adjusting the setting and detecting further subsequent vibrations until the target threshold is met.

16. The method of claim 9, further comprising:
receiving a signal indicating an anticipated impact of the vehicle;
selectively adjusting a state of the at least one actively controlled valve based at least in part on the received signal; and
modifying a pressure distribution within the plurality of bladders to enhance impact absorption or adjust a position of a user.

17. A cushion system for a seat, comprising:
a plurality of bladders, wherein each of the plurality of bladders is made at least partially of an elastic material;
wherein the cushion system comprises at least one of the following features:
(i) at least one passive relief valve configured to vent air from at least one of the plurality of bladders when a pressure within the at least one bladder exceeds a predetermined threshold; or
(ii) at least one bladder of the plurality of bladders includes a portion that is structurally modified relative to one or more other portions of the at least one bladder, wherein the structurally modified portion is configured to rupture in a controlled manner when subjected to a predetermined pressure such that air vents at a predetermined rate through the resulting opening in the at least one bladder.

18. The cushion system of claim 17, wherein the cushion system comprises the at least one passive relief valve.

19. The cushion system of claim 17, wherein the cushion system comprises the structurally modified portion.

20. The cushion system of claim 17, further comprising:
at least one actively controlled valve configured to selectively adjust air flow into or out of at least one of the plurality of bladders; and
at least one controller configured to adjust a state of the at least one actively controlled valve.
